(19) United States
(12) Patent Application Publication
(10) Pub. No.: US 2012/0247507 A1
(43) Pub. Date: Oct. 4, 2012

(54) Oil Cleaning Tool and Method of Use

(76) Inventor: Richard Newlon, Junction City, KS (US)

(21) Appl. No.: 13/079,119

(22) Filed: Apr. 4, 2011

(51) Int. Cl. B08B 1/00

(52) U.S. Cl. 134/6; 15/209.1

(57) ABSTRACT

An oil cleaning tool comprising an elongated handle extending vertically from a floor; an absorption piece attached to a bottom portion of the elongated handle; a bracket with a plate connecting the absorption piece to the elongated handle wherein the bracket allows the absorption piece to slide along the floor when the elongated handle is moved by a user over a layer of oil. The absorption piece may be a piece of wood or a piece of plastic covered with an absorbent material to disperse the layer of oil against the floor. Additionally, the bracket may removably attach the elongated handle to the absorption piece.

### BACKGROUND OF THE INVENTION

1. Field of the Invention

The present invention relates to a mop-like tool to clean and disperse a layer of oil on a floor wherein the tool comprises an elongated handle attached to a wood piece to work the oil into the floor.

2. Description of Related Art

Oil spills are common misfortunes in auto shops, on frequently traveled roads and in residential garages. Essentially, an oil spill may be found anywhere where vehicles travel and may have developed a leak. Typically, when an oil spill is encountered the person must use a large quantity of paper towel or absorbent pads to wipe, absorb and clear the mess. A great deal of effort is used while the person is on their hands and knees wiping the floor which may cause physical pain and injuries to the person's body. Besides the paper product waste, the person's time spent bending and wiping is wasted which could be spent performing more productive activities.

While a variety of mops and brooms are currently available, a mop to clean the floor of a shop or street is still needed. Additionally, tools have been developed for oil cleanup on a body of water, but such tools do not translate to cleaning on land. For example, U.S. Pat. No. 5,084,171 by Michael P. Murphy discloses an oil recovery mop wherein a number of oil-absorbing pads are suspended from a carriage that is attached to a back portion of a boat. At each end of the carriage are small pontoons to allow the carriage to float on water. The oil-absorbing pads are used to absorb a top layer of oil that may be floating on the water's surface.

It would be beneficial in the art to provide an oil cleaning tool that allows a user to clean an area of spilled oil while standing upright rather without requiring the user to clean the mess on their hands and knees. It would also be desirable in the art to provide an oil cleaning tool that is easy to use and store.

### SUMMARY OF THE INVENTION

In view of the foregoing disadvantages inherent in the prior art, the purpose of the present disclosure is to provide a mop-like tool to clean and disperse a layer of oil on a floor wherein the tool comprises an elongated handle attached to a wood piece to work the oil into the floor.

An object of the present invention is to provide an oil cleaning tool that works a layer of oil into the floor and into the tool itself.

Another object of the present invention is to provide an oil cleaning tool that includes a removable handle to allow for greater portability and storage of the tool.

To achieve the above objects, in an aspect of the present invention, an oil cleaning tool is disclosed comprising an elongated handle extending vertically from a floor; an absorption piece attached to a bottom portion of the elongated handle; a bracket with a plate connecting the absorption piece to the elongated handle wherein the bracket allows the absorption piece to slide along the floor when the elongated handle is moved by a user over a layer of oil. The absorption piece may be a piece of wood or a piece of plastic covered with an absorbent material to disperse the layer of oil against the floor. Finally, the bracket may removably attach the elongated handle to the absorption piece.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 depicts a perspective view of an oil cleaning tool in accordance with an exemplary embodiment of the present invention.

### DETAILED DESCRIPTION OF THE DRAWINGS

The present invention relates to a mop-like tool to clean and disperse a layer of oil on a floor wherein the tool comprises an elongated handle attached to a wood piece to work the oil into the floor. The present invention provides an oil cleaning tool as a quick and efficient method of cleaning oil spills. The oil cleaning tool attaches an absorbent wood piece to a handle with a metal bracket and a set of screws. The metal bracket may allow the handle to removably attach to the absorbent wood piece for easy storage. During use, the user simply slides the absorbent wood piece across the floor by moving the handle back and forth. The layer of spilled oil is then worked into the floor and the wood to eliminate the slipperiness of the oil and sufficiently dry out the spill.

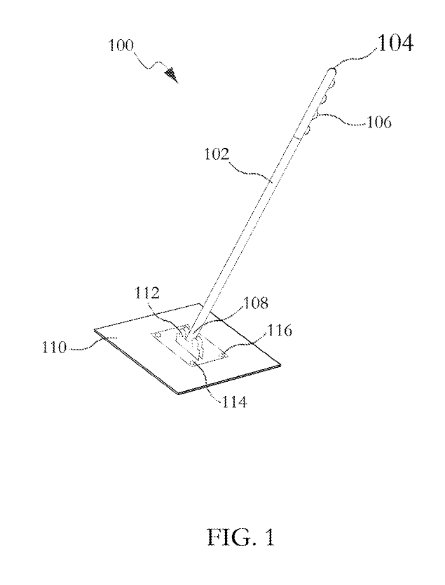

Tuning now descriptively to the drawings, referring to FIG. 1, a perspective view of a oil cleaning tool (100) is shown in accordance with an exemplary embodiment of the present invention. The oil cleaning tool (100) includes an elongated handle (102) extending vertically from an absorption piece (110) resting against the floor. The elongated handle (102) may be comprised of a polished wood or lightweight plastic for a comfortable feel against a user's hands. At a top portion of the elongated handle (102) may be a gripping handle (104) with a set of grooves (106) for a more ergonomic gripping area along the elongated handle (102). The gripping handle (104) may be made from a hard plastic, a soft rubber or foam material thereby providing a soft-grip comfort handle for the user.

The absorption piece (110) may comprise a square shape (as shown), a circle, a rectangle or any other appropriate shape known and used in the art. The absorption piece (110) may be a piece of wood or a piece of plastic covered with an absorbent material each having the ability to absorb and/or spread a layer of oil or other viscous liquid. The size of the absorption piece (110) may vary depending on the surface area the absorption piece (110) used to clean. For example, if the oil cleaning tool (100) is used for residential purposes the absorption piece (110) may be a small piece, approximately one foot square. Alternatively, if used for industrial purposes the absorption piece (110) may be larger to quickly cover a larger floor space.

At a lower end (108) of the elongated handle (102), a bracket (112) connects the elongated handle (102) to the absorption piece (110). The bracket (112) is attached to the absorption piece (110) with a plate (114). The plate (114) may be a metal plate or a hard plastic plate held in place with a set of screws (116) for greater stability. The bracket (112) may allow for removable attachment of the elongated handle (102) for greater portability and storage simplicity. The bracket (112) enables the elongated handle (102) to bend back and forth against the absorption piece (110) while still providing enough support against the plate (114) for the elongated handle (102) to control how the absorption piece (110) moves. As such, the elongated handle (102) enables the absorption piece (110) to rotate, swivel and glide along the floor during use, coinciding with the movements of the elongated handle (102).

To use the oil cleaning tool (100), the user grasps the gripping handle (104) with one hand and the elongated handle (102) with the other hand. The user then moves the handle (102) to slide the absorption piece (110) back and forth over the oil. The absorption piece (110) may glide above the oil in circular, side-to-side or figure eight strokes or a combination thereof to allow the oil to work into the floor and absorption piece (110). By spreading the oil and working it into the floor, the spilled surface becomes less slippery and the oil layer is dispersed to allow it to quickly dry and prevent oil accumulation.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An oil cleaning tool comprising:
an elongated handle extending vertically from a floor;
an absorption piece attached to a bottom portion of said elongated handle;
a bracket with a plate connecting said absorption piece with said elongated handle wherein said bracket allows said absorption piece to slide along the floor when said elongated handle is moved by a user over a layer of oil.

2. The oil cleaning tool according to claim 1, wherein said plate is secured against said absorption piece with a set of screws.

3. The oil cleaning tool according to claim 1, wherein said absorption piece is a piece of wood.

4. The oil cleaning tool according to claim 1, wherein said absorption piece is a piece of plastic covered with an absorbent material.

5. The oil cleaning tool according to claim 1, wherein said bracket allows for removable attachment of said handle to said absorption piece.

6. The oil cleaning tool according to claim 1, wherein a top portion of said elongated handle includes a gripping handle with a set of grooves for a more comfortable grip for said user.

7. A method of use for an oil cleaning tool comprising the steps of:
gripping an elongated handle;
moving said elongated handle to thereby slide an absorption piece, attached to a bottom portion of said elongated handle, along a floor covered with a layer of oil; and
working said layer of oil into said floor to disperse said layer of oil.

8. The method of use for said oil cleaning tool further comprising the step of moving said elongated handle in a combination of side-to-side strokes, circular strokes and figure eight strokes.
